(19) United States
(12) Patent Application Publication
(10) Pub. No.: US 2014/0312835 A1
(43) Pub. Date: Oct. 23, 2014

(54) ELECTRONIC APPARATUS AND CHARGER

(71) Applicant: Panasonic Corporation, Osaka (JP)

(72) Inventor: Tomoki Katsumata, Kanagawa (JP)

(73) Assignee: Panasonic Corporation, Osaka (JP)

(21) Appl. No.: 14/258,306

(22) Filed: Apr. 22, 2014

(30) Foreign Application Priority Data
Apr. 23, 2013 (JP) 2013-090610

(51) Int. Cl. H02J 7/02

(52) U.S. Cl. CPC H02J 7/025
USPC 320/108

(57) ABSTRACT

An electronic apparatus includes a power receiving unit configured to receive power, and a secondary battery configured to be charged on the basis of the power received by the power receiving unit. The electronic apparatus operates based on a discharge current of the secondary battery and is capable of communicating, to the outside, an instruction relating to a power transmission suspension time which is varied in accordance with an operation state of the electronic apparatus.

### BACKGROUND

The present invention relates to an electronic apparatus having a contactless charging function and a charger.

In recent years, electronic apparatus having a contactless charging function (e.g., portable terminals such as smartphones) have come to be marketed. Among contactless charging devices used in electronic apparatus of this kind are the non-contact power transmission device disclosed in JP-A-2008-236968 and the contactless power transmission system disdosed in JP-A-2008-178195.

The non-contact power transmission device disclosed in JP-A-2008-236968 is composed of a power transmission device and a power receiving device. The power transmission device transmits power to the power receiving device via a primary coil and a secondary coil which are coupled to each other electromagnetically. In an operation of recharging a secondary battery after its full charging, the power transmission device drives the primary coil every time prescribed timing arrives, detects a current flowing through the primary coil after a lapse of a prescribed time from the start of its driving, and performs a subsequent operation of driving the primary coil on the basis of the detected current.

The contactless power transmission system disclosed in JP-A-2008-178195 is also composed of a power transmission device and a power receiving device. The performs controls to suspend ordinary power transmission to the power receiving device and start intermittent power transmission if it is detected that a secondary battery of a load apparatus has been rendered in a fully charged state and to restart ordinary power transmission to the power receiving device if it is detected in an intermittent power transmission period that the secondary battery has been rendered in a state that continuous recharging is necessary. In the intermittent power transmission period, the power receiving device performs a control to transmit, to the power transmission device, a recharging command for notification of information relating to a recharging state of the secondary battery.

A charging cradle (charger) as a power transmission device is known which has a function of performing a recharging (re-transmission of power) control after full charging. The recharging control is performed using a timer which is provided in the charging cradle. That is, recharging is started upon a lapse of a time that is set in the timer.

Incidentally, in the non-contact power transmission device disclosed in JP-A-2008-236968, intermittent power transmission is performed during suspension of ordinary charging and charging currents are monitored. However, since charging is performed even without a voltage drop of the secondary battery, power is consumed uselessly and overcharging may occur.

Also in the contactless power transmission system disclosed in JP-A-2008-178195, since intermittent power transmission is performed during suspension of ordinary charging, power is consumed uselessly and overcharging may occur.

Likewise, in the above-described charging cradle, since intermittent power transmission is performed substantially during suspension of charging, power is consumed uselessly and overcharging may occur.

Where the above-described charging cradle which performs recharging every prescribed time is used in an electronic apparatus having a contactless charging function, recharging cannot be performed until a lapse of the prescribed time even if a voltage drop occurs in the secondary battery after ordinary charging was suspended because of full charging. This may cause an event that the secondary battery may run down before a restart of ordinary charging when a program that is heavy in load is being run.

### SUMMARY

The present invention has been made in the above circumstances, and an object of the invention is therefore to provide an electronic apparatus and a charger which make it possible to keep the voltage of a secondary battery constant while it is charged after full charging as well as to save power during its recharging.

The invention provides an electronic apparatus comprising:

a power receiving unit configured to receive power; and

a secondary battery configured to be charged on the basis of the power received by the power receiving unit,

wherein the electronic apparatus operates based on a discharge current of the secondary battery and is capable of communicating, to the outside, an instruction relating to a power transmission suspension time which is varied in accordance with an operation state of the electronic apparatus.

In the above-configured electronic apparatus, since the power transmission suspension time that is communicated to a charger is varied in accordance of the operation state of the electronic apparatus itself, the voltage of the secondary battery can be kept constant while it is charged after full charging. Furthermore, power can be saved in contract to the case of intermittent charging.

The above electronic apparatus may be such as to further comprise a display unit capable of displaying a name of prescribed program being run, and the suspension time is varied in accordance with the program being run.

With this configuration, the user can recognize a program being run because its name is displayed. Furthermore, since the suspension time is varied in accordance with a program being run, charging can be performed in accordance with the program being run.

The above electronic apparatus may be such that the prescribed program includes a first program and a second program, and a suspension time corresponding to the first program is set shorter than a suspension time corresponding to the second program if the first program consumes more power while being run than the second program.

With this configuration, since the suspension time corresponding to the first program which consumes more power than the second program is set shorter than that corresponding to the second program, charging can be performed in accordance with the program being run.

The above electronic apparatus may be such that the suspension time is varied in accordance with a power consumption. With this configuration, since the suspension time is varied in accordance with the power consumption, charging can be performed in accordance with the power consumption.

The above electronic apparatus may be such that the suspension time is shortened as the power consumption increases. With this configuration, since the suspension time is shortened as the power consumption increases, charging can be performed in accordance with the power consumption.

The above electronic apparatus may further comprise a power consumption detection unit capable of detecting at least a current consumption. With this configuration, since a current consumption can be detected, charging can be performed in accordance with the power consumption.

The above electronic apparatus may be such that the power receiving unit comprises an electromagnetic coil.

The above electronic apparatus may be such that the instruction relating to the suspension time is transmitted via the power receiving unit.

The invention also provides a charger comprising a power transmission unit for transmitting power, wherein the charger suspends or restarts power transmission according to an instruction relating to a power transmission suspension time which is communicated from the outside.

The above charger may be such as to suspend power transmission when receiving the instruction relating to the power transmission suspension time from the outside, and to restart power transmission upon a lapse of the suspension time.

The above charger may be such that the power transmission unit comprises an electromagnetic coil.

The above charger may be such that the instruction relating to the suspension time is received via the power transmission unit.

The above charger may be such as to receive power from an external, commercial power source.

The invention also provides an electronic apparatus charging system comprising the above electronic apparatus and the above charger.

With this configuration, the voltage of the secondary battery constant while it is charged after full charging and power can be saved during its recharging.

The invention makes it possible to keep the voltage of a secondary battery constant while it is charged after full charging as well as to save power during its recharging.

### BRIEF DESCRIPTION OF THE DRAWINGS

FIG. 1 is a block diagram showing a general configuration of an electronic apparatus charging system according to an embodiment of the present invention.

FIG. 2 is a flowchart showing how a control unit and a contactless charging control unit of an electronic apparatus and a power transmission control unit of a charger operate in the electronic apparatus charging system of FIG. 1.

FIG. 3 shows the format of a packet that is used for a communication between the electronic apparatus and the charger in the electronic apparatus charging system of FIG. 1.

FIG. 4 is a flowchart showing how the control unit 13 and the contactless charging control unit of the electronic apparatus and the power transmission control unit of the charger operate in a case that the electronic apparatus checks an application being run to measure a terminal load.

### DETAILED DESCRIPTION OF EXEMPLARY EMBODIMENTS

A preferred embodiment for carrying out the present invention will be hereinafter described in detail with reference to the drawings.

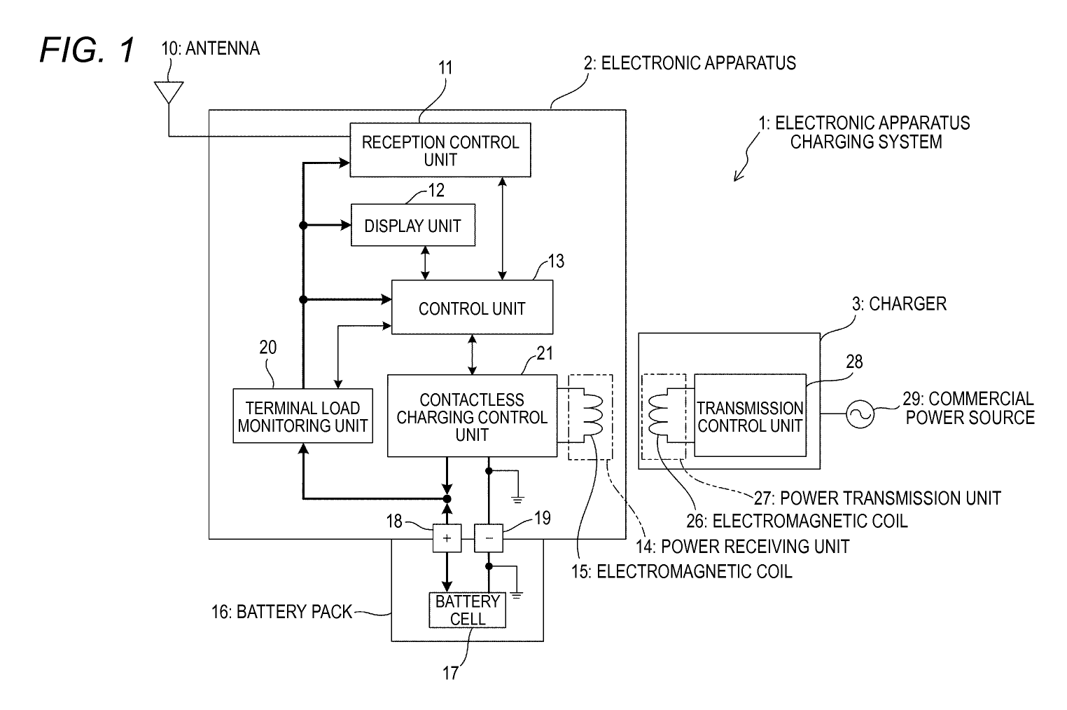

FIG. 1 is a block diagram showing a general configuration of an electronic apparatus charging system according to the embodiment of the invention. An electronic apparatus of the electronic apparatus charging system according to the embodiment is a portable terminal having a function of receiving a multimedia broadcast.

As shown in FIG. 1, the electronic apparatus charging system 1 according to the embodiment at least includes an electronic apparatus 2 and a charger 3. The electronic apparatus 2 is equipped with an antenna 10, a reception control unit 11, a display unit 12, a control unit 13, a power receiving unit 14, a battery pack 16, a terminal load monitoring unit (power consumption detection unit) 20, and a contactless charging control unit 21. The reception control unit 11 receives a multimedia broadcast via the antenna 10. The display unit 12 displays a multimedia broadcast received by the reception control unit 11 and various kinds of information that are produced when the electronic apparatus 2 is used, such as the name of an application program being run.

The control unit 13, which controls the individual units of the electronic apparatus 2, is equipped with a CPU (central processing unit), a ROM (read-only memory) which is stored with programs for controlling the CPU, and a RAM (random access memory) which is used in association with operation of the CPU. The control unit 13 exchanges control signals, operation signals, etc. with each of the reception control unit 11, the display unit 12, the terminal load monitoring unit 20, and the contactless charging control unit 21. Having an electromagnetic coil 15, the power receiving unit 14 receives power that is transmitted from the charger 3. The charger 3 is used as a charging cradle of the electronic apparatus 2. In charging a secondary battery of the electronic apparatus 2, the electronic apparatus 2 is put on the charger 3.

The terminal load monitoring unit 20 operates on a discharge current of a battery cell (secondary battery) 17 of a battery pack 16, and supplies a major part of the discharge current to the reception control unit 11, the display unit 12, and the control unit 13. And the terminal bad monitoring unit 20 detects a current consumed in each of the reception control unit 11, the display unit 12, and the control unit 13. Having such a structure as to be able to be attached to and detached from the apparatus body, the battery pack 16 is electrically connected to the electronic apparatus 2 via a “+” terminal 18 and a “−” terminal 19 when attached to the apparatus body.

The contactless charging control unit 21 operates on first power (which is approximately equal to power capable of activating the contactless charging control unit 21) received by the receiving unit 14, and charges the battery cell 17 of the battery pack 16 using second power (which is approximately equal to power capable of charging the battery cell 17) received by the receiving unit 14. When the battery cell 17 has been charged fully, the contactless charging control unit 21 gives a notice to that effect to the control unit 13. When receiving re-transmission-of-power time information and a charging suspension instruction from the control unit in response to the above notice, the contactless charging control unit 21 suspends the charging of the battery cell 17 of the battery pack 16 and then communicates the re-transmission-of-power time and a power transmission suspension instruction to the charger 3. When power transmission from the charger 3 is restarted upon a lapse of the re-transmission-of-power time, the contactless charging control unit 21 restarts charging of the battery cell 17.

When receiving, from the contactless charging control unit 21, a notice to the effect that the battery cell 17 has been charged fully, the control unit 13 measures a load (referred to as a terminal load) of the electronic apparatus 2 on the basis of respective current consumptions of the reception control unit 11, the display unit 12, and the control unit 13 detected by the terminal load monitoring unit 20. And the control unit 13 determines a re-transmission-of-power time on the basis of a terminal load measurement result The re-transmission-of-power time is set shorter as the terminal load increases. A power consumption can be detected by detecting a current if the voltage is constant.

The control unit 13 gives the determined re-transmission-of-power time to the contactless charging control unit 21 and instructs the contactless charging control unit 21 to suspend the charging. When receiving the re-transmission-of-power time information and the charging suspension instruction from the control unit 13, the contactless charging control unit 21 communicates the re-transmission-of-power time and a power transmission suspension instruction to the charger 3. The re-transmission-of-power time means a power transmission suspension time. When informed of the re-transmission-of-power time, the charger 3 suspends the power transmission for that time. The charger 3 restarts power transmission upon a lapse of that time.

The charger 3, which supplies charging power to the battery cell 17 of the battery pack 16, is equipped with a power transmission unit 27 having an electromagnetic coil 26 and a power transmission control unit 28 which suspends and restarts power transmission by controlling the power transmission unit 27 in response to a re-transmission-of-power time notice that is received from the electronic apparatus 2. The power transmission unit 27 transmits charging power via the electromagnetic coil 26. Power is exchanged through electromagnetic coupling between the electromagnetic coil 26 provided on the side of the charger 3 and the electromagnetic coil 15 provided on the side of the electronic apparatus 2. The power transmission control unit 28 suspends the power transmission until a lapse of the re-transmission-of-power time according to the re-transmission-of-power time and the power transmission suspension instruction that are transmitted from the electronic apparatus 2 when the battery cell 17 has been charged fully. The power transmission control unit 28 is supplied with power from an external, commercial power source 29.

Next, a description will be made of how the electronic apparatus 2 and the charger 3 of the electronic apparatus charging system 1 according to the embodiment operate.

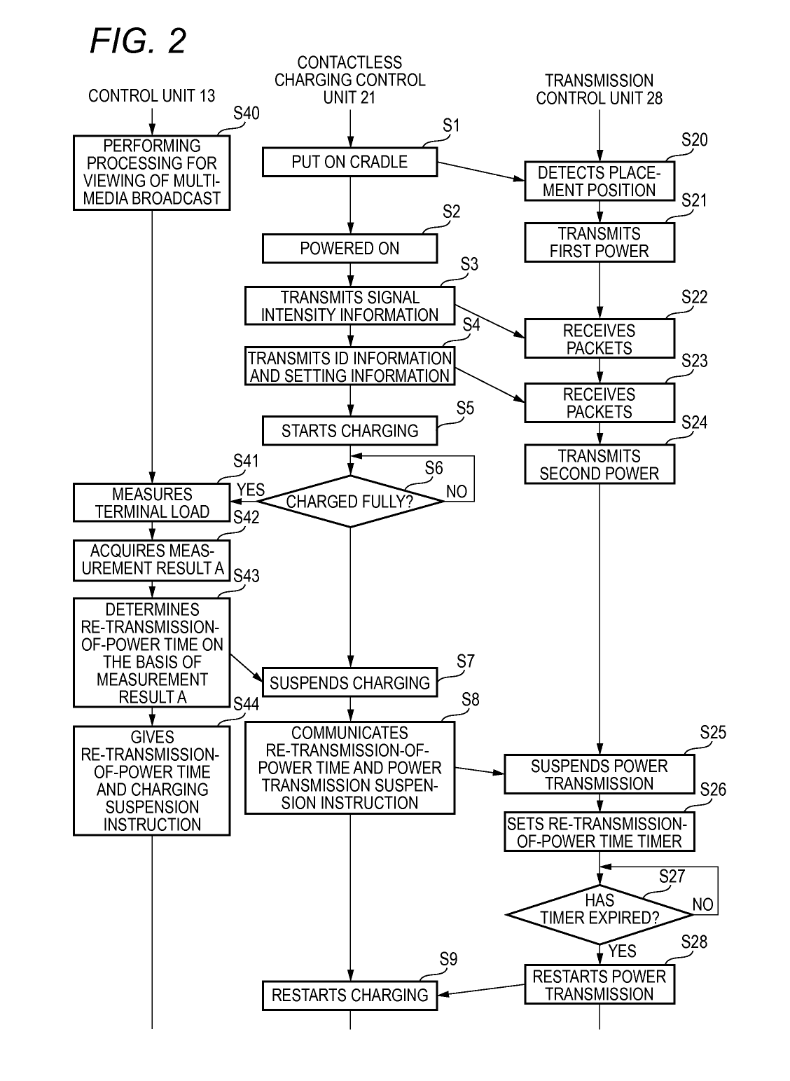

FIG. 2 is a flowchart showing how the control unit 13 and the contactless charging control unit 21 of the electronic apparatus 2 and the power transmission control unit 28 of the charger 3 operate. It is noted that FIG. 2 includes steps that correspond to manipulations of a user.

When the electronic apparatus 2 is put on the charger which is a charging cradle (step S1), at step 320 the power transmission control unit 28 of the charger 3 detects the placement of the electronic apparatus 2 and a placement position. At step S21, the power transmission control unit 28 transmits power (first power) that is approximately equal to power capable of activating the contactless charging control unit 21 of the electronic apparatus 2.

Receiving that power (first power) from the charger 3, at step S2 the contactless charging control unit 21 of the electronic apparatus 2 is powered on (i.e., activated). At step S3, the activated contactless charging control unit 21 transmits signal intensity information to the charger 3 in the form of packets. At step S4, the contactless charging control unit 21 transmits ID information and setting information to the charger 3 in the form of packets. Where the contactless charging control unit 21 etc. are implemented as an integrated circuit, the ID information may contain a manufacturer code of the integrated circuit or a basic device identifier of the integrated circuit (device) in the same manufacturer. Or the ID information may contain identification information corresponding to the electronic apparatus 2. Steps S3 and S4 are based on the WPC (Wireless Power Consortium) standard or the like.

At step S22 and S23, the power transmission control unit 28 of the charger 3 receives the signal intensity information, the ID information, and the setting information which are transmitted from the electronic apparatus 2. Upon receiving these pieces of information, at step S24 the power transmission control unit 28 transmits power (second power; e.g., a little less than 4 W) that is approximately equal to power capable of charging the battery cell 17 of the electronic apparatus 2. Steps S20-S24 are based on the WPC (Wireless Power Consortium) standard or the like.

Receiving that power (second power) from the charger 3, at step S5 the contactless charging control unit 21 of the electronic apparatus 2 starts charging of the battery cell 17. At step S6, the contactiess charging control unit 21 judges whether or not the battery cell 17 has been charged fully. If judging that the battery cell 17 has not been charged fully yet (S6: no), the contactless charging control unit 21 executes step S6 repeatedly until the battery cell 17 is charged fully. If judging that the battery cell 17 has been charged fully (S6: yes), the contactless charging control unit 21 informs the control unit 13 of that fact.

If receiving a notice to the effect that the battery cell 17 has been charged fully from the contactless charging control unit 21 while performing processing for viewing of a multimedia broadcast at step S40, at step S41 the control unit 13 measures a terminal load using the terminal load monitoring unit 20. The terminal load monitoring unit 20 measures respective current consumptions of the reception control unit 11, the display unit 12, and the control unit 13 of the electronic apparatus 2. Upon acquiring a terminal load measurement result (referred to as a measurement result A) at step S42, at step S43 the control unit 13 determines a re-transmission-of-power time on the basis of the measurement result A. At step S44, the control unit 13 informs the contactless charging control unit 21 of the re-transmission-of-power time and instructs the contactless charging control unit 21 to suspend the charging.

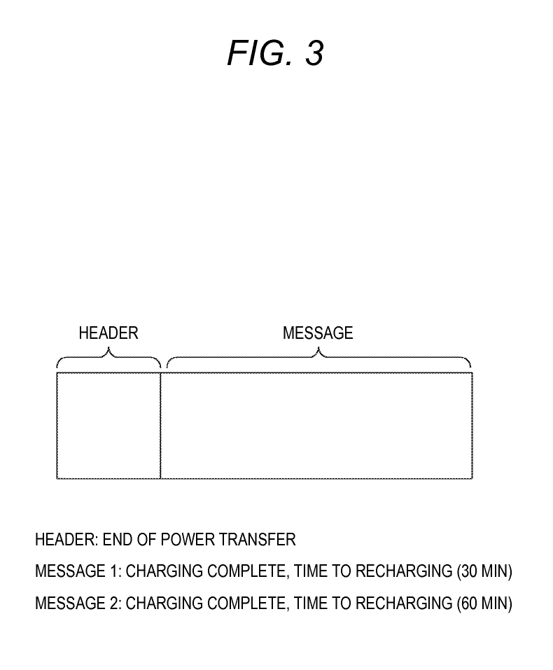

At step S7, the contactless charging control unit 21 suspends the charging of the battery cell 17 in response to the charging suspension instruction received from the control unit 13. At step S8, the contactless charging control unit 21 communicates the re-transmission-of-power time and a power transmission suspension instruction to the power transmission control unit 28 of the charger 3. FIG. 3 shows a format of a packet that is used for a communication between the electronic apparatus 2 and the charger 3. As shown in FIG. 3, this packet consists of a header and a message. The header contains a statement “end of power transfer” and the message contains a statement “charging complete, a time to recharging (e.g., 30 or 60 min).”

At step S25, the power transmission control unit 28 of the charger 3 suspends the power transmission according to the received power transmission suspension instruction. At step S26, the power transmission control unit 28 sets a re-transmission-of-power time timer on the basis of the received re-transmission-of-power time. The re-transmission-of-power time is shorter when the terminal load is heavier. At step S27, the power transmission control unit 28 judges whether the timer has expired or not. If judging that the timer has not expired yet (S27: no), the power transmission control unit 28 executes step S27 again. If judging that the timer has expired (S27: yes), the power transmission control unit 28 restarts power transmission.

If the charger 3 restarts power transmission and the contactless charging control unit 21 of the electronic apparatus 2 receives the resulting power, at step S9 the contactless charging control unit 21 restarts charging of the battery cell 17.

As described above, in the electronic apparatus charging system 1 according to the embodiment, when the battery cell 17 has been charged fully, the electronic apparatus 2 suspends the charging and communicates a re-transmission-of-power time corresponding to the magnitude of a terminal load to the charger 3. As a result, the voltage of the battery cell 17 can be kept constant while it is charged after full charging. Furthermore, the charger 3 suspends power transmission when receiving a power transmission suspension instruction from the electronic apparatus 2, and restarts power transmission upon a lapse of a suspension time. As a result, power can be saved during recharging of the battery cell 17.

In the electronic apparatus 2 of the electronic apparatus charging system 1 according to the embodiment, a terminal load is measured when the battery cell 17 has been charged fully. Alternatively, a terminal load may be measured immediately before suspension of the power transmission that follows full charging of the battery cell 17.

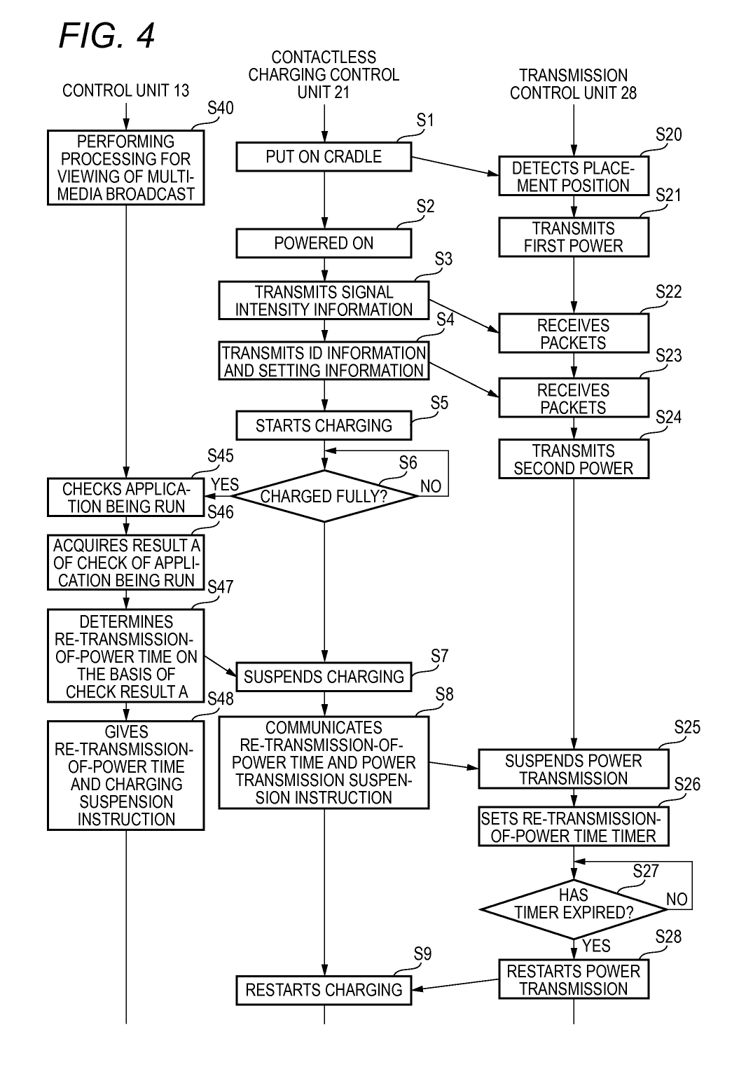

In the electronic apparatus 2 of the electronic apparatus charging system 1 according to the embodiment, a terminal load is measured by measuring respective current consumptions of the reception control unit 11, the display unit 12, and the control unit 13. Alternatively, an application (program) being run may be checked. FIG. 4 is a flowchart showing how the control unit 13 and the contactless charging control unit 21 of the electronic apparatus 2 and the power transmission control unit 28 of the charger 3 operate in the case that the electronic apparatus 2 checks an application being run to measure a terminal load. The steps shown in FIG. 4 are the same as the above-described steps shown in FIG. 2 except steps at which the control unit 13 checks an application being run, determines a re-transmission-of-power time on the basis of a check result, and informs the contactless charging control unit 21 of it. Descriptions of those common steps will be omitted.

When receiving a notice to the effect that the battery cell 17 has been charged fully from the contactless charging control unit 21 while performing processing for viewing of a multimedia broadcast, at step S45 the control unit 13 checks an application being run. When acquiring an application check result (referred to as a check result A) at step S46, at step S47 the control unit 13 determines a re-transmission-of-power time on the basis of the check result A. At step S48, the control unit 13 informs the contactless charging control unit 21 of the re-transmission-of-power time and instructs the contactless charging control unit 21 to suspend the charging.

Assume here that a program being run includes at least a first program and a second program and the first program consumes more power while being run than the second program. In this case, at step S26, the power transmission control unit 28 sets the timer in such a manner that the suspension time corresponding to the first program is set shorter than that corresponding to the second program. Since the timer is set for a short time for a program that consumes large power, power transmission can be restarted before the battery cell 17 runs down.

In the electronic apparatus charging system 1 according to the embodiment, a suspension time (re-transmission-of-power time) is used to command suspension of power transmission. However, any information corresponding to a suspension time may be used for this purpose. For example, two values “long” and “short” may be used instead of specific time lengths.

The electronic apparatus charging system 1 according to the embodiment consists of the electronic apparatus 2 having the function of receiving a multimedia broadcast and the charger 3 which is a charging cradle of the electronic apparatus 2. However, it is also possible to form an electronic apparatus charging system by an electronic apparatus having a function of receiving a digital moving image over a wired or wireless network and decoding and displaying it and a charger as its charging cradle or by an electronic apparatus which is a slave unit of a wired telephone and a charger as its charging cradle.

Providing the advantages that the voltage of a secondary battery can be kept constant while it is charged after full charging and power can be saved during its recharging, the invention can be applied to electronic apparatus such as portable terminals having a contactless charging function.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japanese Patent Application No. 2013-090610 filed on Apr. 23, 2013, the contents of which are incorporated herein by reference.

1. An electronic apparatus comprising:
a power receiving unit configured to receive power; and
a secondary battery configured to be charged on the basis of the power received by the power receiving unit,
wherein the electronic apparatus operates based on a discharge current of the secondary battery and is capable of communicating, to the outside, an instruction relating to a power transmission suspension time which is varied in accordance with an operation state of the electronic apparatus.

2. The electronic apparatus according to claim 1, further comprising:
a display unit capable of displaying a name of prescribed program being run,
wherein the suspension time is varied in accordance with the program being run.

3. The electronic apparatus according to claim 2, wherein the prescribed program includes a first program and a second program; and
wherein a suspension time corresponding to the first program is set shorter than a suspension time corresponding to the second program if the first program consumes more power while being run than the second program.

4. The electronic apparatus according to claim 1, wherein the suspension time is varied in accordance with a power consumption.

5. The electronic apparatus according to claim 4, wherein the suspension time is shortened as the power consumption increases.

6. The electronic apparatus according to claim 4, further comprising:
a power consumption detection unit capable of detecting the current consumption.

7. The electronic apparatus according to claim 1, wherein the power receiving unit includes an electromagnetic coil.

8. The electronic apparatus according to claim 1, wherein the instruction relating to the suspension time is transmitted via the power receiving unit.

9. A charger comprising:
a power transmission unit configured to transmit power,
wherein the charger suspends or restarts power transmission according to an instruction relating to a power transmission suspension time which is communicated from the outside.

10. The charger according to claim 9, wherein the charger suspends the power transmission when receiving the instruction relating to the power transmission suspension time from the outside, and restarts the power transmission upon a lapse of the suspension time.

11. The charger according to claim 9, wherein the power transmission unit includes an electromagnetic coil.

12. The charger according to claim 9, wherein the instruction relating to the suspension time is received via the power transmission unit.

13. The charger according to claim 9, wherein the charger receives power from an external commercial power source.

14. An electronic apparatus charging system comprising:
the electronic apparatus according to claim 1.

15. The electronic apparatus charging system of claim 14, further comprising the charger according to claim 9.
